(19) United States
(12) Patent Application Publication
(10) Pub. No.: US 2011/0161796 A1
(43) Pub. Date: Jun. 30, 2011

(54) FormDB: a process to create a forms database in Excel without user programming

(76) Inventor: Edward Charles Laikin, Annandale, VA (US)

(21) Appl. No.: 12/651,329

(22) Filed: Dec. 31, 2009

(51) Int. Cl. G06F 17/00

(52) U.S. Cl. 715/221

(57) ABSTRACT

This program converts a customized Excel form into a form where each record is stored in a database (spreadsheet). Five simple buttons are added to row 1 of the form that allow the creation of new form records, the review of previously submitted form records, and the updating of records. The core of this invention makes custom forms available to non-programmers by annotating the form fields (cells) with comments that tell the form where to store, update, and retrieve the form data.

### CROSS-REFERENCE TO RELATED APPLICATIONS

Not Applicable

### STATEMENT REGARDING FEDERALLY SPONSORED RESEARCH OR DEVELOPMENT

Not Applicable

### BRIEF DESCRIPTION OF THE SEVERAL VIEWS OF THE DRAWING

### DETAILED DESCRIPTION OF THE INVENTION

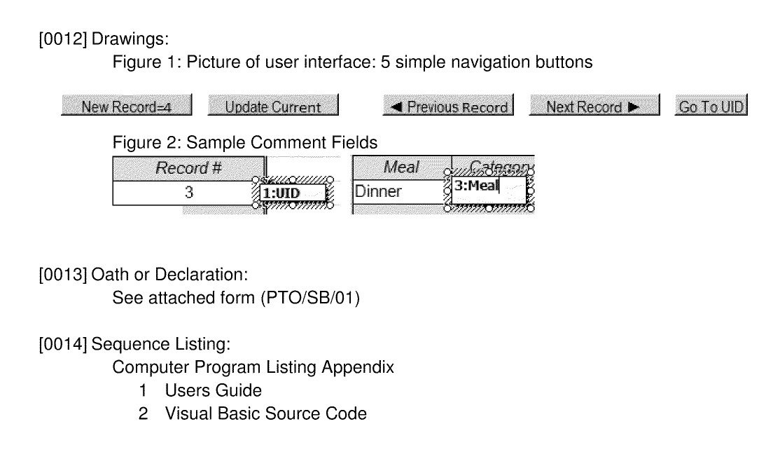

This program converts an Excel form into a form with each record stored in a database (spreadsheet). Five simple buttons are added to row 1 of the form (FIG. 1) that allow the creation of new form records, the review of previously submitted form records, and the updating of form records.

This invention is different from the way Microsoft, Open Office and other spreadsheets handle forms. These other applications have three basic methods for users to build a form to store multiple inputs of data. First, is for the user to use Visual Basic (or other programming language) to build a custom form then write the custom code that tells the form how to process the data and where to store the data. This requires skills beyond most user's abilities. Second is to use a default form function. This function simply creates a list type form that the user can not manipulate to make it into a useful form. Third, and probably the most common method, is where the user puts text and lines into a spreadsheet to make the spreadsheet look like a form. This works great, but does not allow multiple records to be stored in the same spreadsheet. Essentially in this method each record is saved as a separate spreadsheet. This invention allows the user to build forms following the third method, and then add simple comments like those shown in FIG. 2 (e.g. 1:UID, 3:Meal) to indicate where that field should be stored. The user can then save each new record or navigate between records using the 5 simple navigation buttons shown in FIG. 1.

Using this new method requires the user to enter comments in each field that they want recorded. This is a one-time process. However, the advantages are numerous, for example: maintain one file verse many files, reduce storage space, the ability to use pivot tables, graphs, and other analysis tools on all of the data, the ability to modify the table without rewriting Visual Basic code, the ability to move fields around on the form without impacting the already stored data, the ability to build user friendly forms, and empower the average spreadsheet operator with the ability to create and use forms and analyze the data.

The Excel Add-In that I created (FormDB.xla) is one of many possible implementations. In this version the program reads the comment fields that the user entered and uses that information to create a new tab in the spreadsheet to store and retrieve the data.

The above description refers generally to a single embodiment of this invention.

However the invention is not limited to this one implementation. For example a different number of buttons could have been used, menus could replace buttons, and 3d references could replace comments. These and many other implementations are covered by this invention.

1. Ability to use attributes (or combinations of attributes) such as comments, 3D references, colors, fonts . . . to instruct the program on where to store, retrieve, or update the form data.

2. Ability to store, and edit data from customized forms without user programming.

3. Ability to navigate, display, and edit customized form data with a simple user interface.
